(19) United States
(12) Patent Application Publication
(10) Pub. No.: US 2021/0293560 A1
(43) Pub. Date: Sep. 23, 2021

(54) METHODS AND SYSTEMS FOR DETERMINING VEHICLE TRAVEL ROUTES

(71) Applicant: Freeport-McMoRan Inc., Phoenix, AZ (US)

(72) Inventors: Mary Amelia Walker, Phoenix, AZ (US); Nicholas Hickson, Phoenix, AZ (US); Robert Catron, Phoenix, AZ (US); Brian Vaughan, St. Louis, MO (US); Hung Jung Lu, St. Louis, MO (US)

(21) Appl. No.: 17/202,678

(22) Filed: Mar. 16, 2021

Related U.S. Application Data
(60) Provisional application No. 62/990,525, filed on Mar. 17, 2020.

(51) Int. Cl. G01C 21/34

(52) U.S. Cl. CPC G01C 21/3484; G01C 21/3446

(57) ABSTRACT

Systems and methods of determining vehicle travel routes taken by a plurality of vehicles between a plurality of starting locations and a plurality of ending locations may identify a plurality of Trips taken by the vehicles between the starting locations and the ending locations; group the identified plurality of Trips to form Groups of Trips; separate the Groups of Trips to form Collections of Trips; determine a Common Route for each of the Collections of Trips; combine similar Common Routes to form Current Routes; and use the Current Routes to direct future trips to be taken by the vehicles.

### CROSS-REFERENCE TO RELATED APPLICATION

This application claims the benefit of U.S. Provisional Patent Application No. 62/990,525, filed on Mar. 17, 2020, which is hereby incorporated herein by reference for all that it discloses.

### TECHNICAL FIELD

The present invention relates to mining operations in general and more particularly to methods and systems for determining routes for vehicles traveling between a plurality of starting locations and a plurality of ending locations.

### BACKGROUND

Mining operations typically involve the delivery of large amounts of earthen materials, such as excavated ore, to various types of material processing systems to recover metals or other valuable minerals. Such material processing systems may involve one or more comminution or size-reduction steps to reduce the size of the excavated ore from a relatively coarse size to a finer size suitable for subsequent processing. Thereafter, the size-reduced ore may be subjected to any of a wide range of processes to separate the commercially valuable minerals from the waste material or gangue.

In a typical open-pit mining operation, the ore to be mined is periodically fractured (e.g., by blasting). Large shovels are then used to load the fractured ore into haul trucks. The haul trucks carry the excavated ore to various other locations throughout the mine for further comminution and/or processing. Such other locations may include ore crushers, grinders, stockpiles, and waste dumps, just to name a few. Open-pit mining operations are conducted on a large scale and a given open pit mine may involve the use of a large number of shovels, haul trucks, and processing systems in order to process the large volumes of excavated ore involved.

The particular loading and dumping areas assigned to the haul trucks are typically selected by a dispatch system and communicated to the drivers of the haul trucks. After being assigned, the haul trucks will travel between the various loading and dumping areas via a road network provided in the mine. However, the loaded and empty haul trucks do not always travel between the same two pairs of loading and dumping areas. For example, it is common for situations to arise wherein the haul trucks are re-routed to alternate loading and dumping areas in order to optimize the utilization of resources or for other reasons. In addition, the configuration of the mine haul roads is often such that more than one route or path may be taken between any two loading and dumping areas. The expected re-routing of haul trucks and the fact that they may take different paths or routes between the loading and dumping area complicates operations and can make it difficult to achieve desired productivity goals.

### SUMMARY OF THE INVENTION

One embodiment of a computer-implemented method of determining travel routes taken by a plurality of vehicles traveling on roadways between a plurality of starting locations and a plurality of ending locations may involve: Identifying a plurality of Trips taken by the vehicles from the starting locations to the ending locations; grouping, using a computer, the identified plurality of Trips to form Groups of Trips; separating, using the computer, the Groups of Trips to form Collections of Trips; determining, using the computer, a Common Route for each of the Collections of Trips; combining, using the computer, similar Common Routes to form Current Routes; and displaying, using the computer, the Current Routes.

Another method of determining vehicle travel routes may include: Identifying a plurality of Trips taken by the vehicles between the starting locations and the ending locations; grouping the identified plurality of Trips to form Groups of Trips; separating the Groups of Trips to form Collections of Trips; determining a Common Route for each of the Collections of Trips; combining similar Common Routes to form Current Routes; and directing future travel routes trips to be taken by the vehicles based on the Current Routes.

A system for determining vehicle travel routes may include a display system, a database, and a processing system. The processing system is operatively associated with the display system and database and is configured to: Use the database to identify a plurality of Trips taken by the vehicles between the starting locations and the ending locations; group the identified plurality of Trips to form Groups of Trips; separate the Groups of Trips to form Collections of Trips; determine a Common Route for each of the Collections of Trips; combine similar Common Routes to form Current Routes; and display the Current Routes on the display system.

Also disclosed is a non-transitory computer-readable storage medium having computer-executable instructions embodied thereon that, when executed by at least one computer processor cause the computer processor to: Identify a plurality of Trips taken by the vehicles between a plurality of starting locations and a plurality of ending locations; group the identified plurality of Trips to form Groups of Trips; separate the Groups of Trips to form Collections of Trips; determine a Common Route for each of the Collections of Trips; combine similar Common Routes to form Current Routes; and display the Current Routes.

### BRIEF DESCRIPTION OF THE DRAWINGS

Illustrative and presently preferred exemplary embodiments of the invention are shown in the drawings in which:

FIG. 1 is a schematic representation of one embodiment of a system for determining routes to be taken by vehicles traveling between a plurality of starting and ending locations;

FIG. 2 is a schematic representation of various Trips that may be taken between various starting and ending locations;

FIG. 3 is a flow chart representation of one embodiment of a method of determining vehicle travel routes;

FIG. 4 is an aerial view of a portion of an open pit mine having various Trips taken by haul trucks superimposed thereon;

FIG. 5 is a schematic depiction of a haul road intersection illustrating various defined segments of the haul road and related snap points;

FIG. 6(a-c) are aerial views of portions of an open pit mine depicting respective first, second and third Groups of Trips;

FIG. 7(a-c) are aerial views of the portion of the open pit mine shown in FIG. 6c depicting respective first, second, and third Collections of Trips from the third Group of Trips illustrated in FIG. 6c;

FIGS. 8(a-d) are aerial views of the portion of the open pit mine shown in FIGS. 6(a-c) depicting Common Routes;

FIG. 9 is an aerial view of the portion of the open pit mine shown in FIGS. 8(a-d) depicting a Current Route resulting from the combination of the Common Routes depicted in FIGS. 8(a-d);

FIG. 10 is an aerial view of a portion of an open pit mine depicting a plurality of Common Routes;

FIG. 11a is an aerial view of a portion of an open pit mine depicting terminal end segments of a Trip;

FIG. 11b is an aerial view of the portion of the open pit mine shown in FIG. 11(a) with the terminal end segments removed from the Trip;

FIG. 12a is an aerial view of a portion an open pit mine showing gaps in a Trip; and

FIG. 12b is an aerial view of the portion of the open pit mine shown in FIG. 12a with the gaps closed.

### DETAILED DESCRIPTION OF THE PREFERRED EMBODIMENTS

One embodiment of a system 10 for determining vehicle travel routes is shown and described herein as it could be used to determine travel routes for a plurality of vehicles 12 traveling on roadways 14 between one or more starting locations 16 and one or more ending locations 18. More specifically, the system 10 is used to identify or determine travel routes to be followed by haul trucks 20 traveling on haul roads 22 in an open-pit mine 24. Alternatively, the systems and methods shown and described herein could be used in other applications and environments as well.

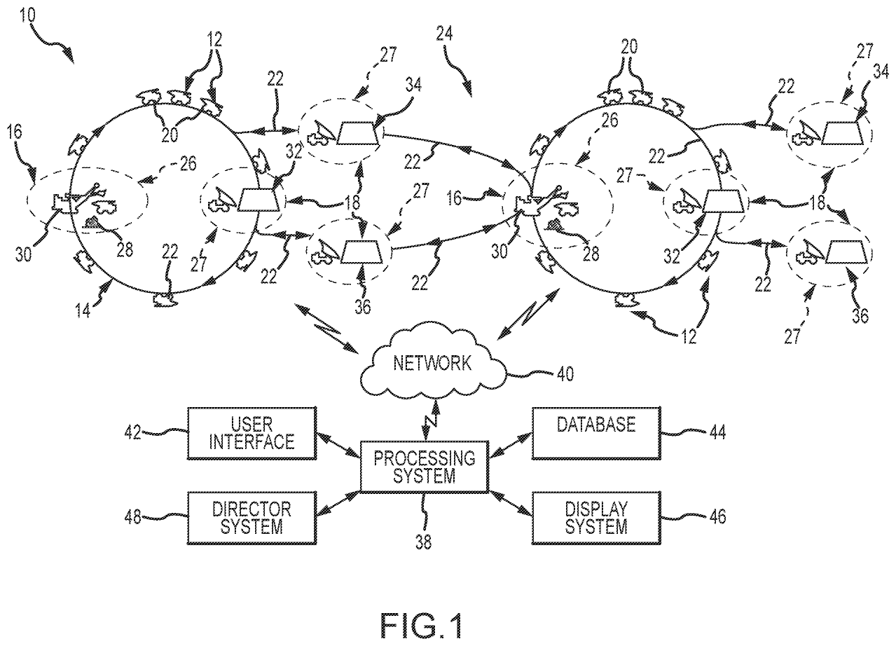

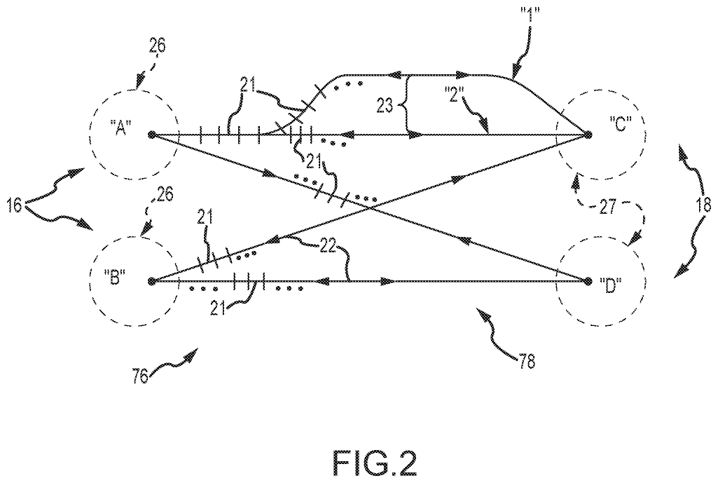

Referring now to FIGS. 1 and 2, the various starting locations 16 may comprise one or more loading areas 26 wherein excavated ore 28 is loaded into the haul trucks 20 by one or more shovels 30. Once loaded, the haul trucks 20 carry the excavated ore 28 to the ending locations 18. The ending locations may comprise one or more dumping areas 27 where the excavated ore 28 is dumped or discharged by the haul trucks 20 for further processing. The dumping areas 27 may comprise, for example, one or more ore crushers 32, stockpiles 34, or other extraction systems 36.

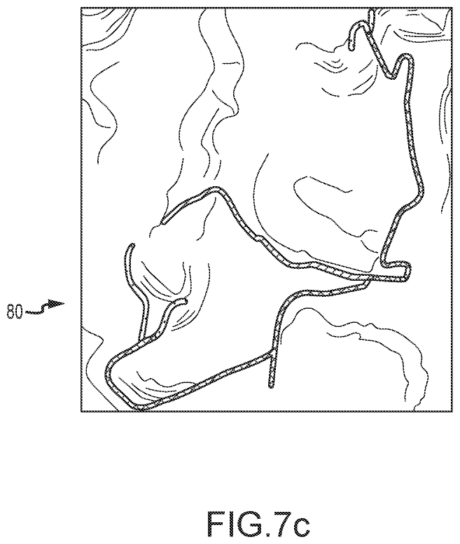

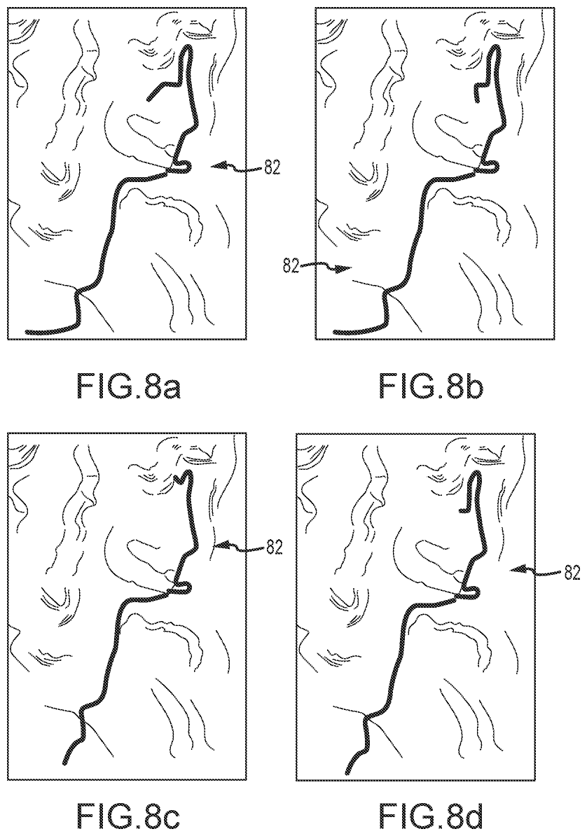

Loaded and empty haul trucks 20 may not always travel or cycle between the same two pairs of starting and ending locations 16 and 18. Moreover, the configuration of the haul roads 22 is typically such that more than one route or pathway 23 (i.e., the particular sequence of individual portions or segments 21 of the haul roads 22) may be taken between any two starting and ending locations 16 and 18, as illustrated schematically in FIG. 2. The systems and methods described herein may be used to identify or choose a travel route, i.e., sequence of haul road segments 21, that should be followed by any particular haul truck 20 to any assigned starting or ending location 16 or 18, as the case may be. As will be explained in greater detail herein, the chosen travel route may also be referred to herein as a “Current Route 74.” Current Routes 74 are illustrated in FIGS. 9 and 10.

Referring back now primarily to FIG. 1, system 10 may comprise a computer processing system 38 that is operatively connected to various systems in the open-pit mine 24 via one or more networks 40. One such system may include a position location system (not shown) associated with each haul truck 20. The position location system is operatively connected to processing system 38 via network 40 so that information and data relating to the location of each haul truck 20 may be communicated to processing system 38. In addition, the various systems associated with loading and dumping areas 26 and 27, such as shovels 30, ore crushers 32, stockpiles 34, or other extraction processes 36, also may be operatively connected to processing system 38, e.g., via network 40, so that information and data relating to the operation of those systems may be communicated to processing system 38.

Processing system 38 also may be operatively connected to a user interface system 42, a database 44, and a display system 46. The user interface system 42 allows one or more users to interface with and control certain aspects of processing system 38. Database 44 may be used to store information and data required by the processing system 38 in order to perform the various functions and method steps shown and described herein. Display system 46 may be used to provide visual depictions or displays of information and data relating to the operation of the system 10 and the routes (e.g., Current Routes 74) traveled by the various haul trucks 20.

Processing system 38 also may be operatively connected to a director system 48. Director system 48 is responsive to information and data produced by the processing system 38 and may be used to direct the future movements of the haul trucks 20 based at least in part on the determined routes, which may include one or more Current Routes 74. In one embodiment, director system 48 may interface with a dispatch system (not shown) associated with the mine 24. As will be explained in greater detail herein, directing the future movement of the haul trucks 20 may include assigning (and/or reassigning) a particular route, e.g., the determined travel route, to be taken to the particular destination. Again, the particular travel route to be taken may be based at least in part on the determined Current Route 74.

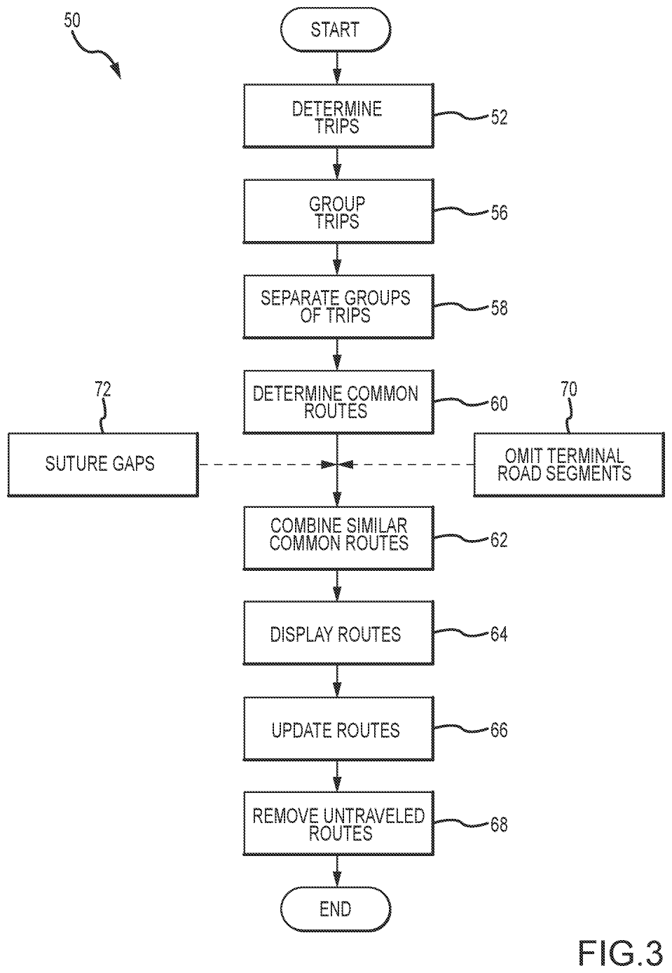

Referring now to FIG. 3, processing system 38 may be configured or programmed to operate in accordance with a method 50 in order to determine Current Routes 74 (FIGS. 9 and 10) taken by the various vehicles 12, e.g., haul trucks 20. As will be described in much greater detail herein, each Current Route 74 represents the most commonly traveled route taken by haul trucks 20 between defined pairs of starting and ending locations 16 and 18. In most instances a determined Current Route 74 will be the travel route favored or preferred to be taken in the future by haul trucks 20 traveling between the particular starting and ending locations 16 and 18. In other instances, such as if the haul truck 20 is to be re-routed, the preferred or favored travel route may only involve certain defined segments of the Current Route 74. In such instances, travel route to be taken by the haul truck 20 nevertheless will be based on the determined Current Route 74, even if that particular Current Route 74 is not to be followed in its entirety.

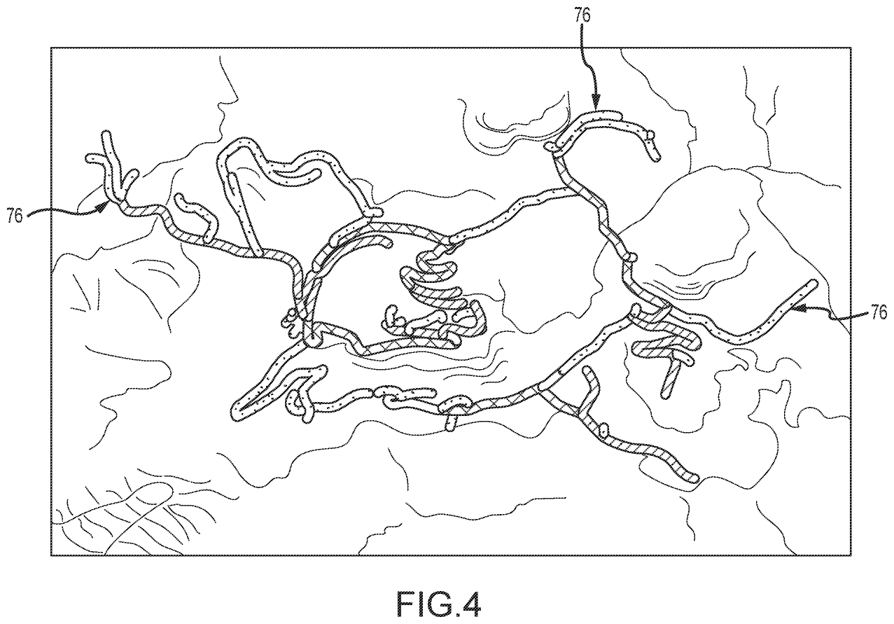

A first step 52 in method 50 involves identifying a plurality of Trips 76 taken by the vehicles 12 (e.g., haul trucks 20) between the various starting and ending locations 16 and 18 within the mine 24. Trips 76 are illustrated schematically in FIG. 2 and pictorially in FIG. 4. In one embodiment, step 52 identifies the Trips 76 based on historical haul truck position data stored in database 44. As best seen in FIG. 2, each identified Trip 76 is the particular pathway 23, i.e., sequence of haul road segments 21, taken by a haul truck 20 between particular starting and ending locations 16 and 18.

A next step 56 of method 50 involves grouping the Trips 76 to form Groups of Trips 78. Each Group of Trips 78 comprises those Trips 76 that have common pairs of starting and ending locations 16 and 18. For example, and with reference now to FIG. 2, in an environment having two possible starting locations 16 (referred to herein as starting locations “A” and “B”) and two possible ending locations 18 (referred to herein as ending locations “C” and “D”), four Groups of Trips 78 are possible: First and second Groups of Trips 78 may be from starting location A to each of ending locations C and D, respectively. Third and fourth Groups of Trips 78 may be from starting location B to each of ending locations C and D, respectively. In such an embodiment, step 56 will group all Trips 76 between starting location A and ending location C into a first Group of Trips 78, whereas step 56 will group all Trips 76 between starting location A and ending location D into a second Group of Trips 78. Similarly, Trips 76 between locations B and C and locations B and D will be grouped or arranged by step 56 into third and fourth Groups of Trips 78, respectively.

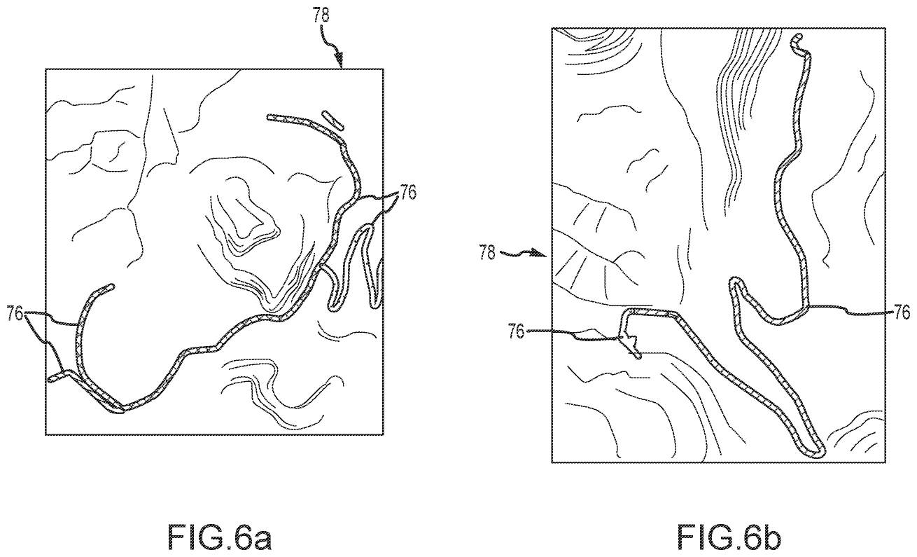

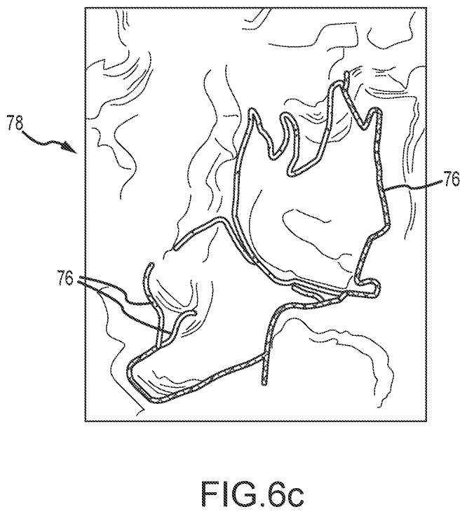

A next step 58 of method 50 involves separating or dividing the Groups of Trips 78 into Collections of Trips 80. See FIGS. 7(a-c). The Collections of Trips 80 illustrated in FIGS. 7(a-c) came from the third Group of Trips 78 illustrated in FIG. 6c. As briefly mentioned above, in many embodiments the network 14 of haul roads 22 will be such that more than one pathway 23, i.e., sequence of road segments 21, may be taken between the particular starting and ending locations 16 and 18 of a particular Group of Trips 78. That is, and as best seen in FIG. 2, there may be more than one pathway 23, i.e., sequence of haul road segments 21, that can be taken between location A and location C. Because step 52 treats each such different pathway 23 as a separate Trip 76, each Group of Trips 78 (e.g, between locations A and C) may include Trips 76 over different pathways 23. Trips 76 in each Group of Trips 78 that involve different pathways 23 are referred to herein as Collections of Trips 80.

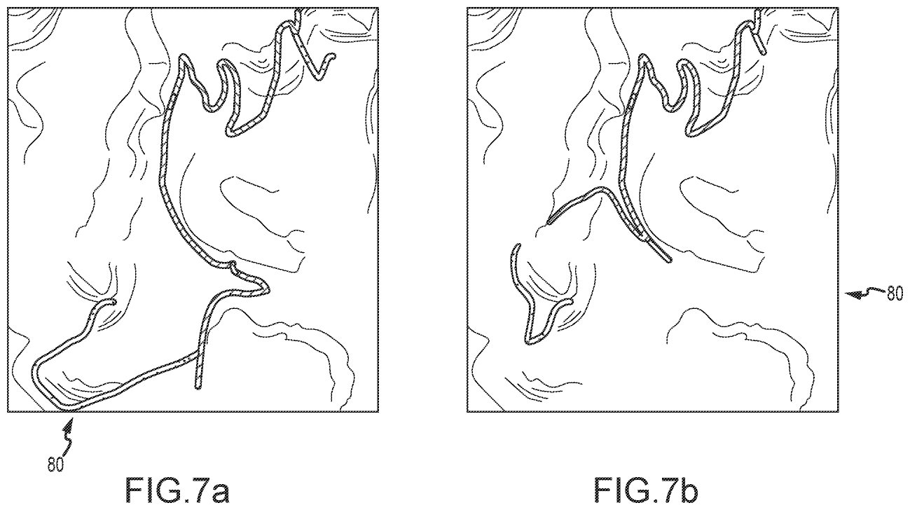

Step 60 of method 50 determines a Common Route 82 for each of the Collection of Trips 78 from step 58. Example Common Routes 82 are depicted in FIGS. 8(a-d). The Common Route 82 for each Collection of Trips 80 is based on the number of times each defined haul road segment 21 (e.g., defined portions of haul roads 22) was traversed by the vehicles 12, e.g., haul trucks 20. Thereafter, step 62 combines similar Common Routes 82 to define the Current Route 74. By way of example, the Current Route 74 depicted in FIG. 9 is the result of the combination of the Common Routes 82 depicted in FIGS. 8(a-d). Step 64 displays the Current Route 74 on display system 46. Such a display may appear substantially as shown in FIG. 9, although other display configurations are possible. In addition, the system 10 may display on display system 46 a plurality of Current Routes 74 taken by both loaded and unloaded haul trucks 20 as they travel from location to location throughout the mine 24, as best seen in FIG. 10. Method 50 may be repeated from time-to-time (e.g., on a daily basis) at step 66 to update the Current Routes 74 as the mining operation progresses. In addition, method 50 may remove untraveled routes at step 68.

A significant advantage of the systems and methods of the present invention is that they may be used to determine travel routes to be followed by the vehicles 12 on a rationalized basis, not just based on location data (e.g., GPS data), which can be inaccurate and result in erroneous conclusions that multiple routes may have been followed by vehicles when in fact the vehicles all followed the same route. Moreover, by accurately determining the routes traveled by vehicles, the present invention simplifies mining operations because vehicle routing decisions and instructions will be based on an accurate and reliable understanding of the various routes traveled by the haul trucks as they are assigned and/or re-assigned to different pairs of starting and ending locations.

Persons having ordinary skill in the art will therefore recognize that the claimed methods and systems can be used to provide a more accurate picture of historical vehicle routes and deployments in order to improve future vehicle routing and deployment decisions over prior art systems. The technical solutions of the methods and systems of the present invention eliminate the need for mine operators or drivers to make vehicle routing and dispatch decisions based on imperfect position data alone. The methods and systems of present invention therefore represent an improvement in the technology of material delivery systems and more particularly to the technology of delivering earthen materials from one or more loading areas to one or more delivery areas.

Having briefly described certain exemplary embodiments of systems and methods of the present invention, as well as some of their more significant features and advantages, various embodiments and variations of the systems and methods of the present invention will now be described in detail. However, before proceeding the description, it should be noted that while the various embodiments are shown and described herein as they could be used in an open pit mining operation to determine travel routes to be taken by haul trucks, the present invention is not limited to use in conjunction with mining applications. To the contrary, the present invention could be used in any of a wide range of applications that involve the need to determine or select among various routes that could be taken by vehicles assigned to cycle between defined pairs of starting and ending locations, as would become apparent to persons having ordinary skill in the art after having become familiar with the teachings provided herein. Consequently, the present invention should not be regarded as limited to use in any particular type of application, environment, or equipment.

Referring back now to FIG. 1, the system 10 for determining vehicle travel routes may be used to determine routes, e.g., Current Routes 74, taken by a plurality of vehicles 12 traveling on a road network 14 between a plurality of starting and ending locations 16 and 18. In the particular embodiments shown and described herein, the system 10 is used to identify or determine Current Routes 74 (depicted in FIGS. 9 and 10) taken by a fleet of haul trucks 20 traveling on haul roads 22 provided in an open-pit mine 24. The determined Current Routes 74 may be used to direct future movements of the haul trucks 20 as they travel between various pairs of starting and ending locations 16 and 18.

In the open-pit mine 24, the various starting locations 16 may comprise one or more loading areas 26, whereas the ending locations 18 may comprise one or more dumping areas 27. As briefly described above, excavated ore 28 is loaded into the haul trucks 20 by one or more shovels 30 in the loading areas 26. The excavated ore 28 is then dumped or discharged for further processing in the dumping areas 27. In a mining operation, such as open-pit mine 24, the dumping areas 27 may comprise one or more ore crushers 32, stockpiles 34, or other extraction systems 36, as best seen in FIG. 1.

The particular starting and ending locations 16 and 18 (i.e., loading and dumping areas 26 and 27) assigned to each haul truck 20 may be selected by a dispatch system (not shown) and communicated to the driver (not shown) of haul trucks 20. After being assigned, the haul trucks 20 travel between the various starting and ending locations 16 and 18 via the haul roads 22 comprising the haul road network 14. Haul trucks 20 traveling from a starting location 16 to an ending location 18 are typically loaded with excavated ore 28 and may be referred to herein as loaded haul trucks. Similarly, haul trucks 20 traveling from an ending location 18 to a starting location 18 may be referred to herein as empty haul trucks.

As noted earlier, loaded and empty haul trucks 20 may not always travel or cycle between the same two pairs of starting and ending locations 16 and 18. For example, in certain situations the loaded and empty haul trucks 20 may be re-assigned or re-routed to alternate starting or ending locations 16 and 18 (e.g., by the dispatch system) in order to optimize the utilization of resources, such as, for example, the carrying capacity of the haul truck fleet or the processing capacities of the ore crushers 32 or other extraction systems 36. In addition, the configuration of the haul roads 22 is typically such that more than one route or pathway 23, i.e., sequence of haul road segments 21, may be taken between any two starting and ending locations 16 and 18, as best seen in FIG. 2. The determination of the various Current Routes 74 in accordance with the teachings provided herein may be used to chose or identify the particular route or sequence of haul road segments 21 that is to be followed by any particular haul truck 20 between assigned starting or ending locations 16 or 18.

Still referring to FIG. 1, system 10 may also comprise a processing system 38. Processing system 38 may be operatively connected to the various systems in the open-pit mine 24 via one or more networks 40. For example, in some embodiments, each haul truck 20 may be provided with a position location system (not shown). The position location system may provide to processing system 38, e.g., via network 40, information and data relating to the location of the haul truck 20. Each position location system may comprise a global positioning system (GPS)-based sensing system, although other types of position location systems may be used. In addition, various systems associated with loading and dumping areas 26 and 27, such as shovels 30, ore crushers 32, stockpiles 34, or other extraction processes 36, also may be operatively connected to processing system 38, e.g., via network 40. Such systems may be used to provide processing system 38 with information and data relating to the status and operation of those systems.

Processing system 38 may also be operatively connected to a user interface system 42, a database 44, and a display system 46. The user interface system 42 allows one or more users to interface with and control certain aspects of processing system 38. As such, the user interface system 42 may comprise any of a wide range of user interfaces, such as keyboards, touch screens, and pointers, that are now known in the art or that may be developed in the future that are or would be suitable for the proposed application. Database 44 may be used to store information and data required by the processing system 38 in order to perform the various functions and method steps shown and described herein. Display system 46 may be used to provide a visual depiction or display of information and data relating to the operation of the system 10 and the routes traveled by the various haul trucks 20. Of course, other types of information and data may also be displayed on display system 46.

Processing system 38 also may be operatively connected to a director system 48. Director system 48 is responsive to information and data produced by the processing system 38 and may be used to direct the future movements of the haul trucks 20 based at least in part on the Current Routes 74. In one embodiment, director system 48 may interface with the dispatch system (not shown) associated with the mine 24. Directing the future movements of the haul trucks 20 may include assigning (and/or reassigning) a destination (e.g., a particular starting or ending location 16 or 18) for at least one of the haul trucks 20. Directing the future movement of the haul trucks 20 may also include assigning (and/or reassigning) a particular route to be taken to the particular destination. The directing of the future movements of the haul trucks 20 may be based in part on the Current Routes 74 determined by the methods and systems shown and described herein.

As briefly described above, processing system 38 may be configured or programmed to operate in accordance with the methods described herein. In some embodiments, processing system 38 may comprise one or more computer processors. The methods may be embodied in various software packages or modules that are provided on non-transitory computer-readable storage media accessible by processing system 38. The various software packages or modules may be provided with computer-executable instructions that, when performed by processing system 38, cause the processing system 38 to process information and data in accordance with the various methods described herein.

Referring now primarily to FIG. 3, the various components of system 10 may be configured or programmed to operate in accordance with a method 50 in order to determine Current Routes 74 taken by the various vehicles 12, e.g., haul trucks 20. Current Routes 74 are illustrated in FIGS. 9 and 10. As was briefly described above, each Current Route 74 represents the most commonly followed route or pathway 23 taken by haul trucks 20 between defined starting and ending locations 16 and 18.

A first step 52 in method 50 involves identifying a plurality of Trips 76 taken by the vehicles 12, e.g., haul trucks 20, between various starting and ending locations 16 and 18. Example Trips 76 are illustrated schematically in FIG. 2 and pictorially in FIG. 4. Step 52 involves an analysis of data contained in database 44 that relates to previous or historical Trips 76 taken by the haul trucks 20. The data may be obtained from location data provided by the position location systems (not shown) provided on haul trucks 20. The location data may comprise GPS position data (e.g., latitude, longitude, and altitude).

In this regard it should be noted that in certain embodiments the data used by step 52 is not simply the “raw” or unprocessed location data provided position location systems operatively associated with haul trucks 20 because such data often include erroneous data points and ‘outliers’ that bear no relation to the actual positions of the haul trucks 20. Accordingly, it is generally preferred, but not required, to first correlate the location data obtained from the position location systems associated with the haul trucks 20 with the locations of the actual haul roads 22 and/or other terrestrial features of the mine 24.

By way of example, in one embodiment, the location data obtained from the position location systems provided on the haul trucks 20 first may be processed in accordance with the teachings provided in U.S. Pat. No. 10,712,448, entitled “Real-Time Correlation of Sensed Position Data with Terrestrial Features,” which is specifically incorporated herein by reference for all that it discloses. Alternatively, in another embodiment, the location data first may be processed in accordance with the teachings described in U.S. Pat. No. 10,002,109, entitled “Systems and Methods of Correlating Satellite Position Data with Terrestrial Features,” which is also specifically incorporated herein by reference for all that it discloses.

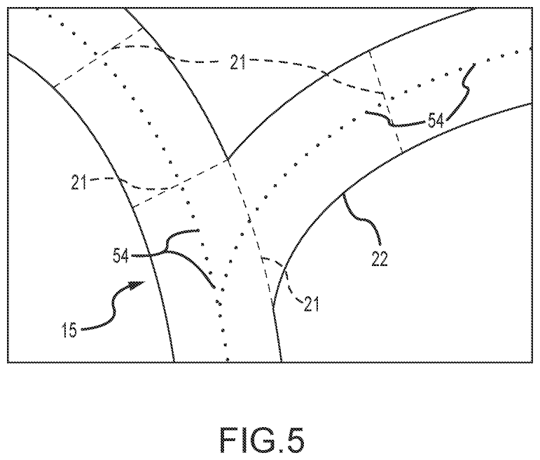

Briefly, the systems and methods described in U.S. Pat. Nos. 10,712,448 and 10,002,109 process the location data by correlating sensed location data (e.g., GPS data provided by the position location systems (not shown) provided on the haul trucks 20) with surveyed data associated with the various haul roads 22 that define the mine road network 14. The surveyed data associated with each haul road 22 may include the locations of various unique snap points 54, as best seen in FIG. 5. Because the snap points 54 are accurately surveyed, thus represent the true locations of the actual haul roads 22, correlating the location data obtained from the position location systems provided on the haul trucks 20 with the snap points 54 will be reflective of the true positions of the haul trucks 20 on the various haul roads 22. In short, the patents referenced herein describe systems and methods for so correlating or “snapping” the sensed location data (e.g., from the position location systems) to the surveyed snap points 54. The systems and methods described in the referenced patents may be used to provide highly accurate and timely position data, typically within about 9 m (about 30 ft.) of the actual positions of the haul trucks 20 within the mine 24. The position data are also updated at high frequency, typically once every second.

The snapped position data produced by the methods and systems disclosed in the referenced patents may be used in step 52 to identify Trips 76 taken by the haul trucks 20 between the various starting and ending locations 16 and 18. More specifically, in step 52, each identified Trip 76 is the particular pathway 23 (FIG. 2) taken by a haul truck 20 over defined segments 21 or portions of the haul roads 22 between particular starting and ending locations 16 and 18. In embodiments wherein each Trip 76 is determined from the snapped position data, each Trip 76 is therefore defined by a plurality of snap points 54.

A next step 56 of method 50 involves grouping the Trips 76 to form Groups of Trips 78. Example Groups of Trips 78 are illustrated schematically in FIG. 2 and pictorially in FIGS. 6(a-c). In the particular embodiments shown and described herein, each Group of Trips 78 comprises those identified Trips 76 that have common pairs of starting and ending locations 16 and 18. For example, and with reference now primarily to FIG. 2, in an environment having two possible starting locations 16, designated as “A” and “B” and two possible ending locations 18, designated as “C” and “D”, four Groups of Trips 78 are possible. In such an embodiment, step 56 will group all Trips 76 between starting location “A” and ending location “C” into a first Group of Trips 78. Step 56 will group all Trips 76 between starting location “A” and ending location “D” into a second Group of Trips 78. In a like manner, trips 76 between locations “B” and “C” and locations “B” and “D” will be grouped or arranged by step 56 into respective third and fourth Groups of Trips 78. Represented pictorially, FIGS. 6(a-c) depict first, second, and third Groups of Trips 78, respectively.

A next step 58 of method 50 involves separating or dividing the Groups of Trips 78 (e.g., as produced by step 56) into Collections of Trips 80. As was briefly mentioned above, in many embodiments the network 14 of haul roads 22 will be such that more than one pathway 23 may be taken between given starting and ending locations 16 and 18. See FIG. 2. That is, there may be more than one sequence of haul roads 22 that can be taken between location “A” and location “C.” Because each such different pathway 23 is regarded as a separate Trip 76 in step 52, each Group of Trips 78 (e.g, between locations “A” and “C” in FIG. 2) may include Trips 76 over different pathways 23. Step 58 separates the Groups of Trips 78 between defined pairs of starting and ending locations 16 and 18 (e.g., between locations “A” and “C”) that involve different pathways 23 or sequences of defined segments 21 of haul roads 22.

For example and still with reference to FIG. 2, if the Trips 76 that were grouped into the first Group of Trips 78 (e.g., those Trips between locations “A” and “C”) reveals that two different pathways 23 (referred to herein as pathways “1” and “2”) were taken by the haul trucks 20 traveling between locations “A” and “C,” then step 58 will separate the Trips 76 in the first Group of Trips 78 (e.g., the Group of Trips between “A” and “C”) into two Collections of Trips 80, each of which corresponds to a different pathway 23 (e.g, pathways “1” and “2”) taken by the haul trucks 20. Represented pictorially, step 58 separated the third Group of Trips 78 illustrated in FIG. 6c into the three Collections of Trips 80, illustrated in FIGS. 7(a-c).

In one embodiment, step 58 uses a data clustering algorithm identify the different pathways 23 taken by the haul trucks 20. Data clustering algorithms are well-known in the art and are commonly used to group data into collections of groups based on certain defined similarities in the data. In the context of the present invention, the data clustering algorithm utilized in step 58 uses the snapped position location data to identify the different pathways 23 taken by the haul trucks 20. That is, different sequences of snapped position location data will mean that a different pathway 23 was followed. However, because data clustering algorithms and techniques are well-known in the art and could be readily provided by persons having ordinary skill in the art after having become familiar with the teachings provided herein, the particular data clustering algorithm that may be used to separate or divide the Groups of Trips 78 to form Collections of Trips 80 will not be described in further detail herein.

Step 60 of method 50 determines a Common Route 82 for each of the Collection of Trips 80 from step 58. Example Common Routes 82 are illustrated pictorially in FIGS. 8(a-d). The Common Route 82 for each Collection of Trips 80 is based on the number of times each defined haul road segment 21 (e.g., defined portions of haul roads 22) was traversed by the haul trucks 20. Thereafter, step 62 combines similar Common Routes 82 to define Current Route 74. By way of example, the Common Routes 82 illustrated in FIGS. 8(a-d) are combined into Current Route 74 illustrated in FIG. 9. In the particular embodiments shown and described herein, similar Common Routes 82, such as those illustrated in FIGS. 8(a-d) are those Common Routes 82 that have greater than about 90% shared snap points 54 (FIG. 5). That is, Common Routes 82 are regarded as being similar if they share least about 90% of the same snap points 54. Step 64 displays on display system 46 the Current Route 74, an example of which is illustrated in FIG. 9. Thereafter, the Current Routes 74 may be used by director system 48 to direct future Trips 76 to be taken by the vehicles 12. Additional information also may be provided on display system 46. For example, in another embodiment, system 10 may display on display system 46 the Current Routes 74 taken by both loaded and unloaded haul trucks 20 as they travel from location to location throughout the mine 24, as best seen in FIG. 10. Method 50 may be repeated from time-to-time (e.g., on a daily basis) at step 66 to update the Current Routes 74 as the mining operation progresses.

In this regard is should be noted that as the mining operation progresses, the various Trips 76 taken by the haul trucks 20 may change. New Trips 76 may be created and existing Trips 76 may cease to be used. If desired, method 50 may remove untraveled routes (e.g., Trips 76) at step 68. For example, if a Trip 76 was used fewer than 50 times during the previous three weeks of operations, then that Trip 76 may be removed from the system 10. Similarly, new Trips 76 may be identified if some defined number, e.g., 50, of new Trips are identified from the position location data.

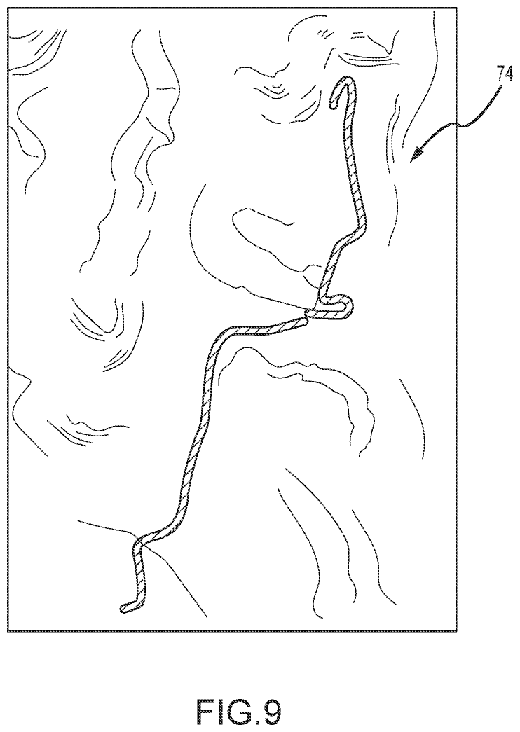

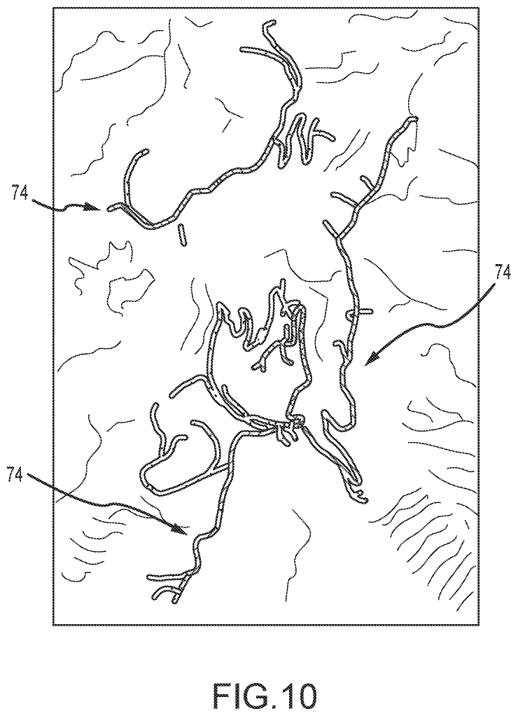

Method 50 may also comprise a number of optional steps that may be provide additional functionalities and features that may be advantageous in certain applications or in certain environments. For example, and with reference now to FIGS. 11(a,b), a first optional step 70 may be used to omit terminal road segments 84 from the various Trips 76. Terminal road segments 84 are those road segments 21 (i.e., defined portions of the haul roads 22) that located at or near the terminal ends, e.g., at either the starting or ending locations 16 and 18, of each Trip 76. The paths taken by the haul trucks 20 at such terminal road segments 84 are typically subject to a high degree of variation due to the nature of the activities undertaken at the terminal road segments 84.

For example, at a given loading area 26 a haul truck 20 may maneuver along a variety different paths adjacent the shovel 30 in order to reach an optimal loading position with respect to the shovel 30. In addition, the shovel 30 will move about within the loading area 26 in order to access new piles or regions of excavated ore 28 as the mining operation proceeds. Similarly, loaded haul trucks 20 may maneuver along a variety of different paths in the dumping area 27 in order dump or discharge the ore at the appropriate location within the dumping area 27. The omission of such terminal road segments 84 from the Trips 76 will improve the overall efficiency of method 50 in that the normally expected path variations at the terminal road segments 84 may be ignored.

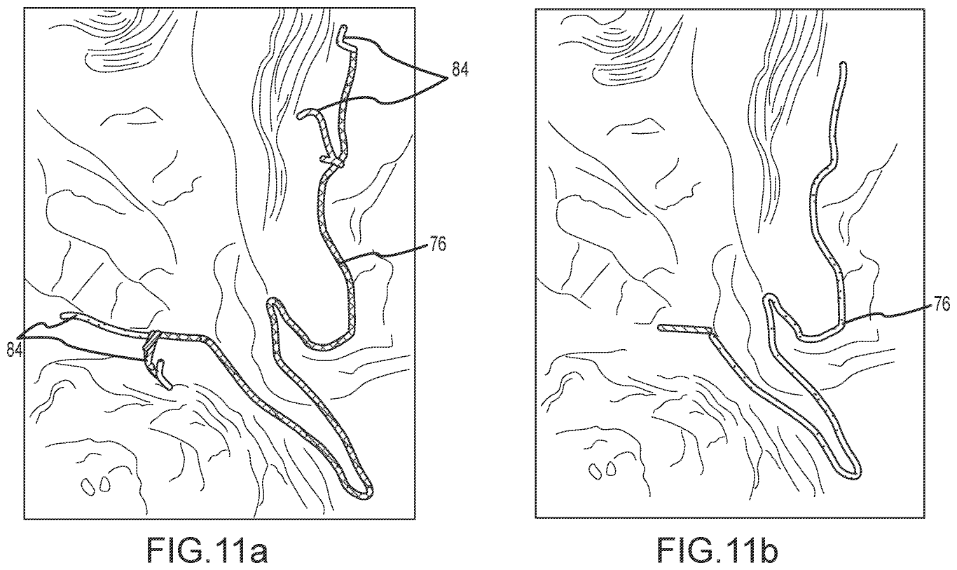

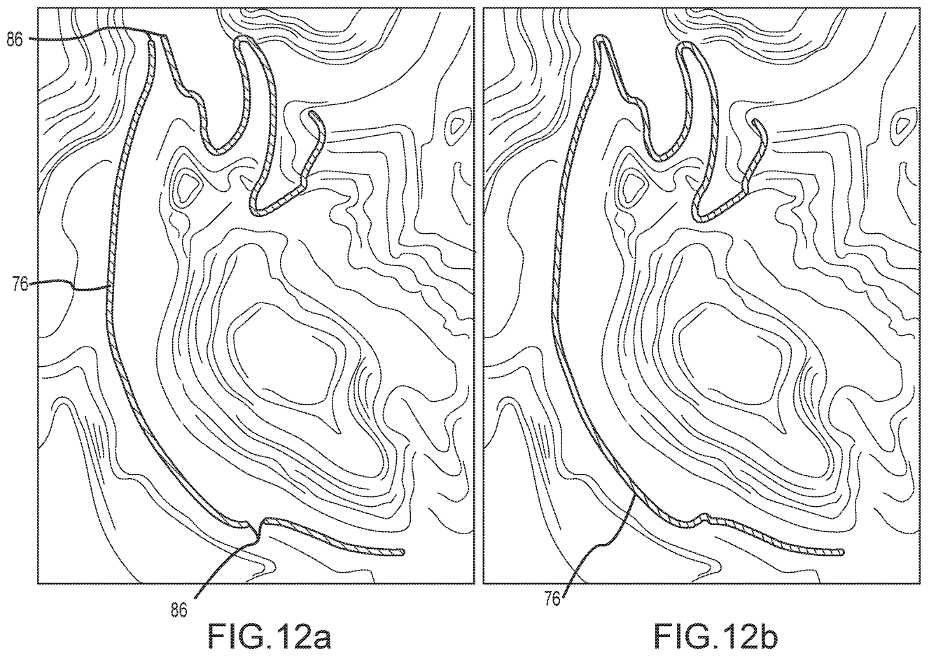

Referring now to FIGS. 12(a,b), another optional step 72 that may be included in method 50 involves a “suturing” operation to close gaps or discontinuities 86 in the Trips 76 determined by method 50. Such gaps 86 may occur as a result in changes in the network 14 of haul roads 22 as the mining operation progresses. Gaps 86 can also occur if small haul road segments 21 (e.g., near a haul road intersection 15, as depicted in FIG. 5) were ignored (e.g., in step 52). Suturing step 72 may utilize a “shortest path” algorithm to close or suture together the gaps 86 with the latest mapped or surveyed segments 21 of the haul roads 22. In one embodiment, the shortest path algorithm used by step 72 may comprise Dijkstra's algorithm. Dijkstra's algorithm is well-known in the art and is commonly used to find the shortest path between nodes in a graph. In the particular embodiments shown and described herein, the nodes represent the various snap points 54 (FIG. 5) whereas the graph represents the network 14 of haul roads 22.

Having herein set forth preferred embodiments of the present invention, it is anticipated that suitable modifications can be made thereto which will nonetheless remain within the scope of the invention. The invention shall therefore only be construed in accordance with the following claims:

1. A computer-implemented method of determining travel routes taken by a plurality of vehicles traveling on roadways from a plurality of starting locations to a plurality of ending locations, comprising:
identifying a plurality of Trips taken by the vehicles from the starting locations to the ending locations;
grouping, using a computer, the identified plurality of Trips to form Groups of Trips;
separating, using the computer, the Groups of Trips to form Collections of Trips;
determining, using the computer, a Common Route for each of the Collections of Trips;
combining, using the computer, similar Common Routes to form Current Routes; and
displaying, using the computer, the Current Routes.

2. The method of claim 1, further comprising directing future trips to be taken by the vehicles based on the Current Routes.

3. The method of claim 1, wherein said identifying the plurality of Trips further comprises determining pathways taken by the vehicles over a plurality of defined road segments associated with each roadway.

4. The method of claim 3, wherein said determining the pathways taken by the vehicles further comprises determining a plurality of snap points associated with the movement of the vehicle over the roadways.

5. The method of claim 4, wherein said determining the plurality of snap points further comprises correlating sensed vehicle position data with the snap points.

6. The method of claim 1, wherein said grouping further comprises:
identifying the starting and ending location for each Trip; and
grouping the Trips based on defined pairs of the starting and ending locations.

7. The method of claim 1, wherein said separating further comprises performing a clustering analysis on the Groups of Trips.

8. The method of claim 3, wherein said determining the Common Route further comprises determining a number of times the defined road segments were traveled by the vehicles.

9. The method of claim 1 further comprising omitting at least one terminal road segment from at least Trip.

10. The method of claim 1, further comprising suturing a gap in at least one Trip.

11. The method of claim 10, wherein said suturing the gap comprises using a shortest path algorithm.

12. The method of claim 11, wherein said using the shortest path algorithm comprises using Dijkstra's algorithm.

13. The method of claim 1, further comprising removing untraveled routes from the Current Routes.

14. A method of determining travel routes taken by a plurality of vehicles traveling on roadways between a plurality of starting locations and a plurality of ending locations, comprising:
identifying a plurality of Trips taken by the vehicles between the starting locations and the ending locations;
grouping the identified plurality of Trips to form Groups of Trips;
separating the Groups of Trips to form Collections of Trips;
determining a Common Route for each of the Collections of Trips;
combining similar Common Routes to form Current Routes; and
directing future travel routes trips to be taken by the vehicles based on the Current Routes.

15. The method of claim 14, wherein said step of directing further comprises directing the vehicles to take the Current Routes.

15. The method of claim 14, wherein said identifying the plurality of Trips further comprises determining pathways taken by vehicles over a plurality of defined road segments associated with each roadway.

16. The method of claim 15, wherein said determining the pathways taken by the vehicles further comprises determining a plurality of snap points associated with the movement of the vehicle over the roadways.

17. The method of claim 16, wherein said determining the plurality of snap points further comprises correlating sensed vehicle position data with the snap points.

18. The method of claim 14, wherein said grouping further comprises:
identifying the starting and ending location for each trip; and
grouping the trips based on defined pairs of the starting and ending locations.

19. The method of claim 14, wherein said separating further comprises performing a clustering analysis on the Groups of Trips.

20. The method of claim 15, wherein said determining the Common Route further comprises determining a number of times the defined road segments were traveled by the vehicles.

21. A non-transitory computer-readable storage medium having computer-executable instructions embodied thereon that, when executed by at least one computer processor cause the computer processor to:
identify a plurality of Trips taken by the vehicles between a plurality of starting locations and a plurality of ending locations;
group the identified plurality of Trips to form Groups of Trips;
separate the Groups of Trips to form Collections of Trips;
determine a Common Route for each of the Collections of Trips;
combine similar Common Routes to form Current Routes; and
display the Current Routes.

22. A system for determining travel routes taken by a plurality of vehicles traveling on roadways between a plurality of starting locations and a plurality of ending locations, comprising:
a display system;
a database; and
a processing system operatively associated with said display system and said database, said processing system being configured to:
use said database to identify a plurality of Trips taken by the vehicles between the starting locations and the ending locations;
group the identified plurality of Trips to form Groups of Trips;
separate the Groups of Trips to form Collections of Trips;
determine a Common Route for each of the Collections of Trips;
combine similar Common Routes to form Current Routes; and
display the Current Routes on said display system.
